(19) United States
(12) Patent Application Publication
(10) Pub. No.: US 2026/0013692 A1
(43) Pub. Date: Jan. 15, 2026

(54) SWIMMING POOL CLEANING ROBOT

(71) Applicant: Ningbo POWERFUL Pool Equipment Co., Ltd, Cixi City (CN)

(72) Inventor: Min Li, Ningbo City (CN)

(21) Appl. No.: 18/891,978

(22) Filed: Sep. 20, 2024

(30) Foreign Application Priority Data
Jul. 11, 2024 (CN) 202410926948.3

(51) Int. Cl. A47L 11/24; A47L 11/40; E04H 4/16

(52) U.S. Cl. CPC A47L 11/24; A47L 11/4041; A47L 11/4069; A47L 11/4072; E04H 4/1654

(57) ABSTRACT

A swimming pool cleaning robot includes a main body, a wheel, a roller brush, a motor, a motor gear, a first transmission gear, a second transmission gear and a roller brush gear. The motor is provided within the main body, and the wheel, the roller brush, the first transmission gear, the second transmission gear and the roller brush gear are each rotatably provided on the main body. The motor gear, the first transmission gear, the second transmission gear and the roller brush gear mesh with one another in a row. The wheel is provided with an external gear ring, and the motor gear is in mesh with the external gear ring. Moreover, axle centers of the motor gear, the first transmission gear, the second transmission gear and the roller brush gear are all below an axle center of the wheel in a vertical direction.

### FIELD OF THE INVENTION

The present invention relates to the field of swimming pool cleaning and, in particular, to a swimming pool cleaning robot.

### BACKGROUND OF THE INVENTION

At present, the cleaning of swimming pools relies mainly on manual cleaning or automatic cleaning equipment. Although manual cleaning can ensure good cleaning results, it is time-consuming, strenuous and inefficient. Automatic cleaning equipment such as swimming pool cleaning robots has found extensive use in the market. Such equipment can reduce manual burden to a certain extent, improve cleaning efficiency and play an important role in the daily maintenance of swimming pools.

Most swimming pool cleaning robots currently available on the market rely on large internal gear rings for power transmission, which tend to introduce considerable mating errors in assembly and manufacturing. In particular, such internal gear rings tend to experience deformations when they are made of a soft material. All these affect power transmission efficiency.

### SUMMARY OF THE DISCLOSURE

In order to overcome the above described problems, the present invention provides:

a swimming pool cleaning robot comprising a main body, a wheel, a roller brush, a motor, a motor gear, a first transmission gear, a second transmission gear and a roller brush gear, wherein the motor is provided within the main body; the wheel, the roller brush, the first transmission gear, the second transmission gear and the roller brush gear are each rotatably provided on the main body; the motor gear, the first transmission gear, the second transmission gear and the roller brush gear mesh with one another in a row; the wheel is provided with an external gear ring and the motor gear is in mesh with the external gear ring; and axle centers of the motor gear, the first transmission gear, the second transmission gear and the roller brush gear are all below an axle center of the wheel in a vertical direction.

Further, a pitch circle diameter of the motor gear may be smaller than a pitch circle diameter of the first transmission gear, which may be equal to a pitch circle diameter of the roller brush gear.

Further, the first transmission gear, the second transmission gear and the roller brush gear may be of the same size.

Further, the wheel may protrude centrally along its axis and thereby define an annular first protrusion, wherein the external gear ring is arranged on the exterior of the annular protrusion.

Further, the robot may further comprise a rear wheel, a rear roller brush and a caterpillar track, the rear wheel rotatably provided on the main body, the rear roller brush coupled to the rear wheel, wherein the wheel is provided with a first gear ring; the rear wheel is provided with a second gear ring; the caterpillar track is provided on its inner side with an inner gear structure engageable with the first gear ring and the second gear ring; and the inner gear structure meshes with the first gear ring and the second gear ring.

Further, the wheel may protrude centrally along its axis and thereby define an annular second protrusion with a diameter greater than a diameter of the first protrusion, wherein the first gear ring is arranged on the exterior of the second protrusion.

Further, the wheel may radially extend outwards on the side proximate the main body to define a first anti-sliding mechanism and may radially extend outwards on the side away from the main body to define a second anti-sliding mechanism, wherein the first gear ring is disposed between the first anti-sliding mechanism and the second anti-sliding mechanism.

Further, the robot may further comprise a wheel cover mounted on the side of the wheel away from the main body, wherein the wheel radially extends outwards on the side proximate the main body to define a first anti-sliding mechanism and the wheel cover has a greater diameter than the wheel and thereby defines a second anti-sliding mechanism extending beyond the wheel, with the first gear ring being disposed between the first anti-sliding mechanism and the second anti-sliding mechanism.

Further, the main body may comprise a housing, securing members and a hermetic compartment, wherein the motor is disposed within the hermetic compartment; the hermetic compartment defines motor protrusions at the motor; the housing defines cutouts on its respective opposite sides; the hermetic compartment is disposed within the housing so that the motor protrusions are located at the cutouts; and the securing members are disposed above the cutouts to restrict the motor protrusions in terms of position.

Further, the main body may define a first reinforcing structure, which is annular in shape, at a joint of the roller brush gear and the roller brush.

Compared with the prior art, the swimming pool cleaning robot of the present invention has the advantages as follows:

The motor is able to actuate both the wheel and the roller brush. Moreover, through providing the first and second transmission gears rotatably on the main body, as well as the motor gear and the external gear ring that are in mesh each other, the use of a large internal gear ring which may introduce mating errors and experience deformations can be circumvented, resulting in increased power transmission efficiency.

### BRIEF DESCRIPTION OF THE DRAWINGS

FIG. 1 shows a first schematic structural view of a swimming pool cleaning robot according to the present invention.

FIG. 2 shows a schematic partial view of a power transmission structure in a swimming pool cleaning robot according to the present invention.

FIG. 3 is a schematic illustration of a wheel in a swimming pool cleaning robot according to the present invention.

FIG. 4 is an exploded view of a power transmission structure in a swimming pool cleaning robot according to the present invention.

FIG. 5 schematically illustrates the internal structure of a swimming pool cleaning robot according to the present invention.

FIG. 6 is a schematic partial structural view of a housing in a swimming pool cleaning robot according to the present invention.

### DETAILED DESCRIPTION OF THE PREFERRED EMBODIMENTS

Aspects, objects, and advantages of the present invention will be described in greater detail below with reference to the accompanying drawings, which illustrate embodiments thereof.

It is to be noted that, the terms “center”, “up”, “down”, “left”, “right”, “vertical”, “horizontal”, “inside”, “outside” and so on may be used herein to describe orientations or positional relationships as viewed in the annexed figures. They are for convenience and ease of description of the present invention only and do not indicate or imply that the described apparatus or element must assume, or be constructed or operated in, a particular orientation. Therefore, they are not to be construed as limiting the present invention. In addition, as used herein, the terms “first”, “second” and “third” are intended only for illustration and are not to be construed as indicating or implying relative importance.

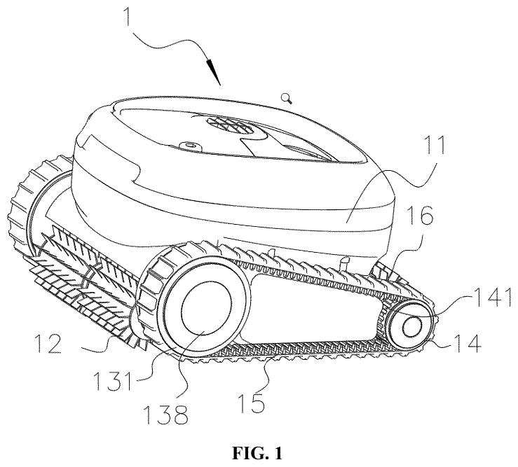

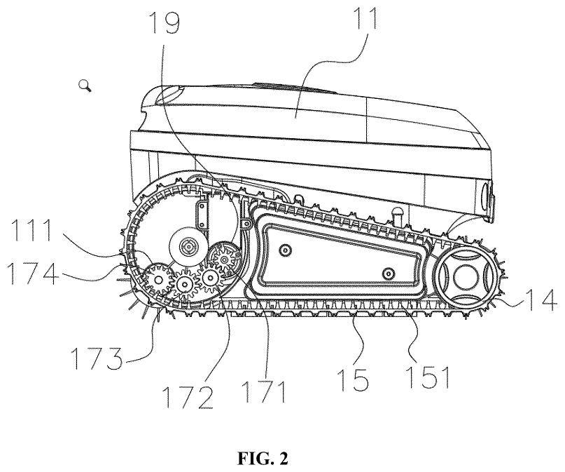

As shown in FIGS. 1 to 3, a swimming pool cleaning robot 1 includes a main body 11, a wheel 131, a roller brush 12, a motor 19, a motor gear 171, a first transmission gear 172, a second transmission gear 173 and a roller brush gear 174. The wheel 131, the roller brush 12, the first transmission gear 172, the second transmission gear 173 and the roller brush gear 174 are each rotatably provided on the main body 11. The motor gear 171, the first transmission gear 172, the second transmission gear 173 and the roller brush gear 174 mesh with one another in a row. The wheel 131 is provided with an external gear ring 133, and the motor gear 171 is in mesh with the external gear ring 133. Moreover, axle centers of the motor gear 171, the first transmission gear 172, the second transmission gear 173 and the roller brush gear 174 are all below an axle center of the wheel 131 in the vertical direction. As can be seen from the above description, through providing the first transmission gear 172 and the second transmission gear 173 rotatably on the main body 11, as well as the motor gear 171 and the external gear ring 133 that are in mesh each other, the use of a large internal gear ring which may introduce mating errors and experience deformations can be circumvented, resulting in increased power transmission efficiency.

In some embodiments, when treating the wheel 131, the roller brush 12, the motor 19, the motor gear 171, the first transmission gear 172, the second transmission gear 173 and the roller brush gear 174 as a single group, two such groups may be provided respectively at left and right sides of the main body 11 and controlled separately to provide differential steering.

Preferably, a pitch circle diameter of the motor gear 171 is smaller than a pitch circle diameter of the first transmission gear 172. Moreover, the pitch circle diameter of the first transmission gear 172 is equal to a pitch circle diameter of the roller brush gear 174. In this way, when the motor gear 171 is rotated by the motor 19, the roller brush 12 rotates at a higher speed than the motor gear 171. This makes the roller brush 12 more powerful in cleaning a swimming pool surface.

Preferably, the first transmission gear 172, the second transmission gear 173 and the roller brush gear 174 are of the same size. Equally sizing these gears can increase their interchangeability and reduce the number of component sizes, resulting in cost savings.

Preferably, the wheel 131 axially protrudes centrally along its own axis, thereby defining an annular first protrusion 132, and the external gear ring 133 is arranged on the exterior of the first protrusion 132. This can facilitate meshing of the external gear ring 133 with the motor gear 171.

Preferably, a rear wheel 14, a rear roller brush 16 and a caterpillar track 15 are also included. The rear wheel 14 is rotatably provided on the main body 11, and the rear roller brush 16 is coupled to the rear wheel 14. The wheel 131 is provided with a first gear ring 135, and the rear wheel 14 is provided with a second gear ring 141. The caterpillar track 15 is provided on its inner side with an inner gear structure 151 engageable with both the first gear ring 135 and the second gear ring 141. The inner gear structure 151 meshes with the first gear ring 135 and the second gear ring 141. Compared with gear-based power transmission, power transmission based on the caterpillar track has better performance in preventing slippery of the swimming pool cleaning robot 1 during walking.

In some embodiments, when treating wheel 131, the roller brush 12, the motor 19, the motor gear 171, the first transmission gear 172, the second transmission gear 173, the roller brush gear 174 and the caterpillar track 15 as a single group, two such groups may be provided respectively at left and right sides of the main body 11 and controlled separately to provide differential steering.

Preferably, the wheel 131 axially protrudes centrally along its axis of rotation, thereby defining an annular second protrusion 134 with a diameter greater than a diameter of the first protrusion 132, and the first gear ring 135 is arranged on the exterior of the second protrusion 134.

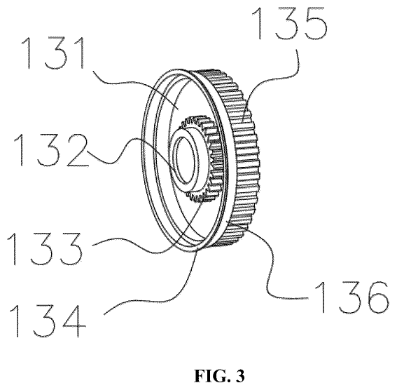

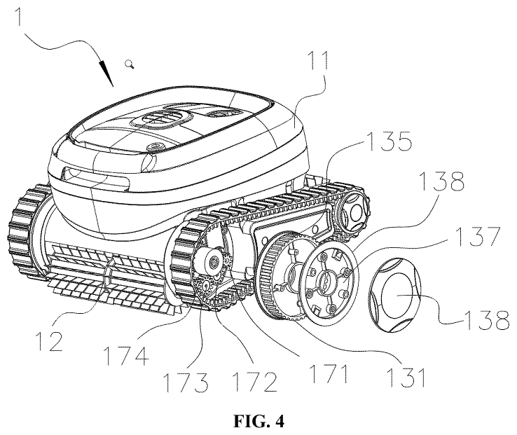

As shown in FIGS. 3 to 4, a wheel cover 137 is also included, which is mounted on the side of the wheel 131 away from the main body 11, and the wheel 131 radially extends outwards on the side proximate the main body 11, defining a first anti-sliding mechanism 136. The wheel cover 137 has a larger diameter than the wheel 131 and thereby defines a second anti-sliding mechanism 138 extending beyond the wheel 131. The first gear ring 135 is disposed between the first anti-sliding mechanism 136 and the second anti-sliding mechanism 138. The first anti-sliding mechanism 136 and the second anti-sliding mechanism 138 serve to prevent the caterpillar track 15 from sliding away.

Preferably, the wheel cover 137 is detachably attached to the wheel 131 in order to facilitate assembly of the caterpillar track 15.

Preferably, the wheel cover 137 is detachably attached to the wheel 131 by snap engagement or threading.

In some embodiments, the wheel 131 radially extends outwards on the side proximate the main body 11 to define a first anti-sliding mechanism 136 and radially extends outwards on the side away from the main body 11 to define a second anti-sliding mechanism 138, with the first gear ring 135 being disposed between the first anti-sliding mechanism 136 and the second anti-sliding mechanism 138.

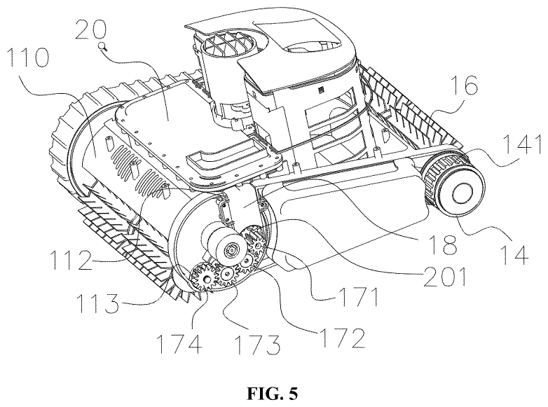

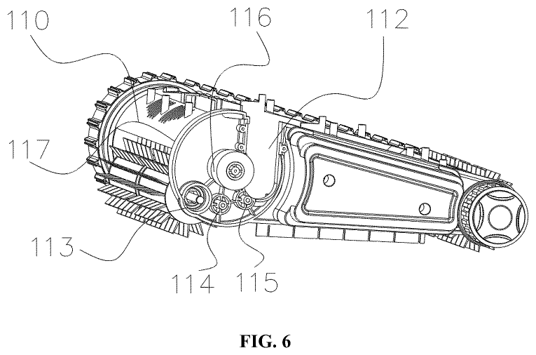

As shown in FIGS. 5 to 6, the main body 11 includes a housing 110, securing members 18 and a hermetic compartment 20. The motor 19 is disposed within the hermetic compartment 20, and the hermetic compartment 20 defines motor protrusions 201 at the motor 19. The housing 110 defines cutouts 112 on its respective opposite sides. The hermetic compartment 20 is disposed within the housing 110 so that the motor protrusions 201 are located at the cutouts 112. The securing members 18 are disposed above the cutouts 112 to restrict the motor protrusions 201 in terms of position. With the cooperation of the cutouts 112 and the securing members 18, the motor protrusions 201 can be mounted through the cutouts 112, allowing the hermetic compartment 20 to have a reduced volume which facilitates its assembly.

Preferably, the housing 110 defines a first reinforcing structure 113 at a joint of the roller brush gear 174 and the roller brush 12.

Preferably, the first reinforcing structure 113 is an annular structure.

Preferably, the housing 110 defines a second reinforcing structure 114 at its joint with the second transmission gear 173.

Preferably, the second reinforcing structure 114 is an annular structure.

Preferably, the housing 110 defines a third reinforcing structure 115 at its joint with the first transmission gear 172.

Preferably, the third reinforcing structure 115 is an annular structure.

Preferably, the housing 110 defines a fourth reinforcing structure 116 at its joint with the wheel 131.

Preferably, the fourth reinforcing structure 116 is an annular structure.

Preferably, the first reinforcing structure 113 and the fourth reinforcing structure 116 are connected by a reinforcing rib provided on the housing 110.

Preferably, the first reinforcing structure 113 and the second reinforcing structure 114 are connected by a reinforcing rib provided on the housing 110.

Preferably, the second reinforcing structure 114 and the third reinforcing structure 115 are connected by a reinforcing rib provided on the housing 110.

Preferably, the second reinforcing structure 114 and the fourth reinforcing structure 116 are connected by a reinforcing rib provided on the housing 110.

Preferably, the third reinforcing structure 115 and the fourth reinforcing structure 116 are connected by a reinforcing rib provided on the housing 110.

Preferably, the housing 110 is arched outwardly, defining an arc-shaped protrusion 117 which increases overall stiffness of the housing 110.

Preferably, the first reinforcing structure 113 is adjacent to or in contact, or integrally formed, with the arc-shaped protrusion 117. This can increase stiffness of the first reinforcing structure 113.

Preferably, the second reinforcing structure 114 and the arc-shaped protrusion 117 are connected by a reinforcing rib provided on the housing 110.

Preferably, the third reinforcing structure 115 and the arc-shaped protrusion 117 are connected by a reinforcing rib provided on the housing 110.

The description presented above is merely that of preferred embodiments of the present invention and is not intended to limit the scope thereof in any sense. Any and all changes, equivalent alternatives and modifications made according to the principles of the invention are intended to fall within the scope thereof.

What is claimed is:

1. A swimming pool cleaning robot comprising a main body, a wheel, a roller brush, a motor, a motor gear, a first transmission gear, a second transmission gear and a roller brush gear, wherein the motor is provided within the main body; the wheel, the roller brush, the first transmission gear, the second transmission gear and the roller brush gear are each rotatably provided on the main body; the motor gear, the first transmission gear, the second transmission gear and the roller brush gear mesh with one another in a row; the wheel is provided with an external gear ring and the motor gear is in mesh with the external gear ring; and axle centers of the motor gear, the first transmission gear, the second transmission gear and the roller brush gear are all below an axle center of the wheel in a vertical direction.

2. The swimming pool cleaning robot of claim 1, wherein a pitch circle diameter of the motor gear is smaller than a pitch circle diameter of the first transmission gear, which is equal to a pitch circle diameter of the roller brush gear.

3. The swimming pool cleaning robot of claim 2, wherein the first transmission gear, the second transmission gear and the roller brush gear are of the same size.

4. The swimming pool cleaning robot of claim 1, wherein the wheel protrudes centrally along its axis and thereby defines an annular first protrusion, wherein the external gear ring is arranged on the exterior of the annular protrusion.

5. The swimming pool cleaning robot of claim 4, further comprising a rear wheel, a rear roller brush and a caterpillar track, the rear wheel rotatably provided on the main body, the rear roller brush coupled to the rear wheel, wherein the wheel is provided with a first gear ring; the rear wheel is provided with a second gear ring; the caterpillar track is provided on its inner side with an inner gear structure engageable with the first gear ring and the second gear ring; and the inner gear structure meshes with the first gear ring and the second gear ring.

6. The swimming pool cleaning robot of claim 5, wherein the wheel protrudes centrally along its axis and thereby defines an annular second protrusion with a diameter greater than a diameter of the first protrusion, wherein the first gear ring is arranged on the exterior of the second protrusion.

7. The swimming pool cleaning robot of claim 5, wherein the wheel radially extends outwards on the side proximate the main body to define a first anti-sliding mechanism and radially extends outwards on the side away from the main body to define a second anti-sliding mechanism, wherein the first gear ring is disposed between the first anti-sliding mechanism and the second anti-sliding mechanism.

8. The swimming pool cleaning robot of claim 5, further comprising a wheel cover mounted on the side of the wheel away from the main body, wherein the wheel radially extends outwards on the side proximate the main body to define a first anti-sliding mechanism and the wheel cover has a greater diameter than the wheel and thereby defines a second anti-sliding mechanism extending beyond the wheel, with the first gear ring being disposed between the first anti-sliding mechanism and the second anti-sliding mechanism.

9. The swimming pool cleaning robot of claim 1, wherein the main body comprises a housing, securing members and a hermetic compartment, wherein the motor is disposed within the hermetic compartment; the hermetic compartment defines motor protrusions at the motor; the housing defines cutouts on its respective opposite sides; the hermetic compartment is disposed within the housing so that the motor protrusions are located at the cutouts; and the securing members are disposed above the cutouts to restrict the motor protrusions in terms of position.

10. The swimming pool cleaning robot of claim 1, wherein the main body defines a first reinforcing structure, which is annular in shape, at a joint of the roller brush gear and the roller brush.
